(19) United States
(12) Patent Application Publication
(10) Pub. No.: US 2023/0419312 A1
(43) Pub. Date: Dec. 28, 2023

(54) Interactive Payment Card Processing System with Application Services

(71) Applicant: Patrick K. Brady, Lombard, IL (US)

(72) Inventors: Patrick K. Brady, Lombard, IL (US); Dana Dominiak, Lemont, IL (US)

(21) Appl. No.: 18/252,725

(22) PCT Filed: Nov. 15, 2021
(86) PCT No.: PCT/US21/59384

§ 371 Date: May 12, 2023

Related U.S. Application Data
(60) Provisional application No. 63/114,505, filed on Nov. 16, 2020.
(60) Provisional application No. 63/243,593, filed on Sep. 13, 2021.

(51) Int. Cl. G06Q 20/38; G06Q 20/02; G06Q 20/40; G06Q 20/20

(52) U.S. Cl. CPC G06Q 20/387; G06Q 20/023; G06Q 20/40; G06Q 20/20

(57) ABSTRACT

A credit card payment system with application services is described. Requirements for modern debit, prepaid and credit card products are becoming increasingly demanding and complex pushing the state of the art. This invention solves the problem of integrated application services and makes it possible to create intelligent payment cards with blended communications and reporting. Intelligence and integration across consumer and back office systems open high value features for cardholders, merchants and banks.

### RELATED APPLICATIONS

This application claims the benefit of U.S. Provisional Patent Application Ser. No. 63/114,505, filed on Nov. 16, 2020 and U.S. Provisional Patent Application Ser. No. 63/243,593, filed on Sep. 13, 2021, the disclosures of which are incorporated by reference herein in their entireties.

### BACKGROUND

### Field of the Invention

Embodiments of the present invention are directed to processing of credit card transactions and information flow related to card use. More specifically, embodiments are directed to credit card transactions, improvements to credit card processing systems and business process improvements.

### Background of the Invention

Consumer credit card processing began in 1946 with the advent of the Charg-it card created by Brooklyn banker John Biggins. Charg-it purchases were forwarded to Biggins' bank where the transaction was settled by payment to the Merchant and payment from the Customer. Diner's Club debuted in 1950 soon becoming the largest “charge card” (Paid in full at the end of each month). American Express reached 1,000,000 customers by 1964 after 5 years of launching their card.

Innovations in the credit card processing industry have centered around better security and embrace of available digital storage and communications technology. At the point of sale, IBM introduced the magnetic stripe to cards in 1960. RFID solutions were added giving way to Europay, MasterCard, and Visa (EMV) computer chip cards in use today. Network interconnections in banking have led to faster and more secure credit card network processing. Fraud prevention software, such as neural networks, began to be introduced in the 1990s with this becoming a robust area of business today (e.g., Actimize, SAS, BAE Systems and others).

### SUMMARY

Embodiments are directed to Credit Card Processing systems or more appropriately Interactive Credit Card Processing systems.

Embodiments bring a number of innovations to the credit card processing industry. One embodiment addresses the need for more advanced rewards cards. In this embodiment, card holders are informed of local Merchant discounts through a smart phone App or website. Affinity cards are issued by an organization to card holders through an Issuing Bank. Use of all affinity cards issued by an Issuing Bank clear through that Issuing Bank. An Application Processor connected to the Issuing Bank either directly or indirectly through a platform server monitors transactions. When an Issuing Bank discovers a transaction from an affinity card issued by that Issuing Bank, the transaction is evaluated for qualifying discounts or other promotions in a database which is part of the Application Server. For a qualified transaction, that is, a transaction the Issuing Bank discovers qualifies for a discount or other promotion (through connection to the Application Server), the Issuing Bank, through the actions of the application server, then assesses fees and adjusts purchase price to reflect the discount or other promotion. Software in the application processor then alerts the card holder to the discount received or other promotion via messaging to the App or via text messaging services.

In another embodiment, Merchants interact with the credit card processing system through a Merchant Portal. In this portal, Merchants are able to set discount levels, establish rules for discount campaigns such as time frames, triggers based on transaction levels, or other data or sets of rules for other promotions. These rules may be combined with their own corporate data such as customer profiles, inventory, staffing, etc. Historical reporting and live dashboard display systems are delivered through the portal in an unprecedented control and display data system for card transaction processing.

In an embodiment, merchant defined discount programs, and/or other promotions are communicated to card holders through an App. Communication may be in the form of active messaging and alerts, or be available passively to those who search using the App. For instance, lunch specials at a restaurant may be offered on a slow day, generating alerts to nearby card holder's Apps. Alternately, or in addition, a lunch special may be defined and discovered through searches performed by App owners.

Merchants have high interest in the results of their campaigns. Card holder's card use creates a definitive trail of use that may feed historical reports or a live dashboard. Such data access leads to feedback into refinement of campaigns through the portal. Card use may also be combined with other data available from the system such as location of the cardholder in the Smartphone App.

In another embodiment, campaign discount levels or other offered benefits, such as other promotions, may be adjusted depending on live data feeds from the Application Server.

### BRIEF DESCRIPTION OF THE FIGURES

FIG. 1 is a system diagram showing elements in an Interactive Credit Card Processing System with Application Services and how they relate to each other.

FIG. 2 is a process diagram with system elements.

FIG. 3 shows the Interactive Control Process main loop message handler with example messages.

FIG. 4 shows a sample message header and example fields from system messages sent between processes.

FIG. 5 shows an example data fields in a Cardholder data structure.

FIG. 6 shows an example of fields in a Merchant data structure.

FIG. 7 shows an example screen of a smartphone App displaying a sample list of Merchants and associated discounts in a local region.

FIG. 8 shows standard payment card transaction Authorization Request message flow between system elements.

FIG. 9 shows standard payment card transaction Authorization Response message flow between system elements.

FIG. 10 shows discount payment card transaction Authorization Request message flow between system elements.

FIG. 11 shows discount payment card transaction Authorization Response message flow between system elements.

FIG. 12 shows fields available in the Square POS transaction processing message payload as part of their API.

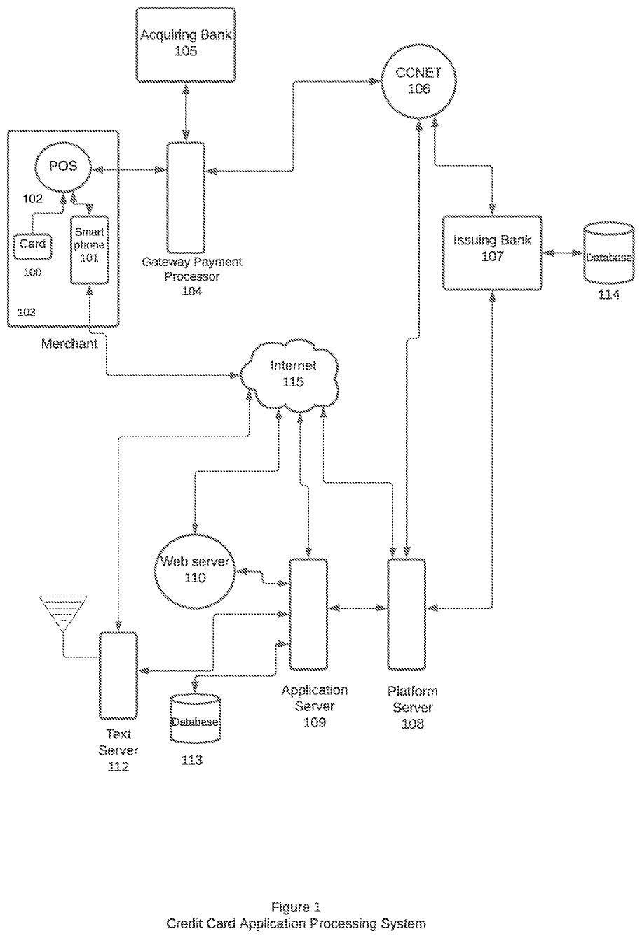

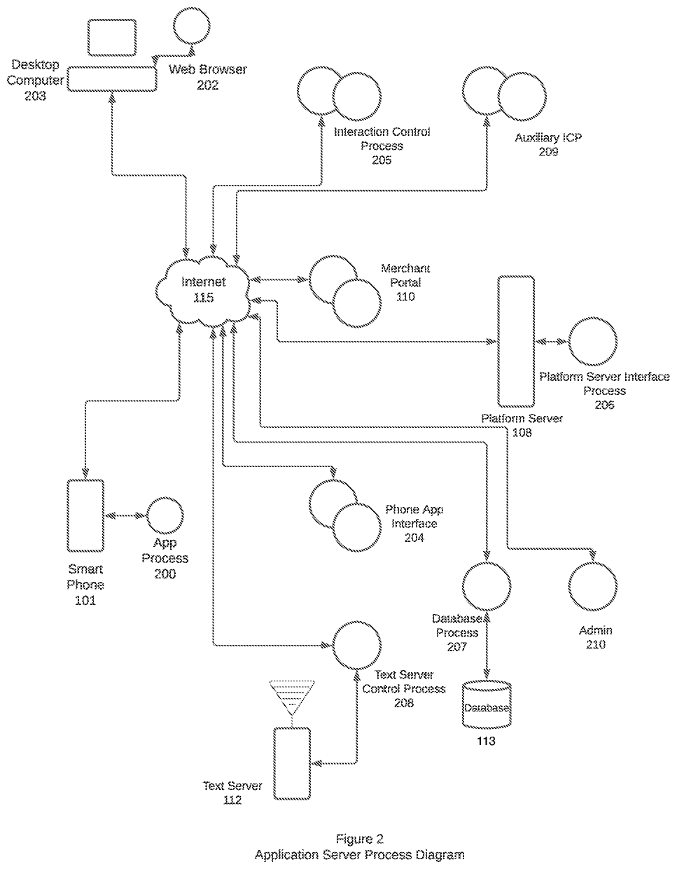

Table 1 and Table 2 show the most commonly used message types and fields from ISO 8583 financial system protocol.

### DETAILED DESCRIPTION

In one embodiment, an affinity company would like to attract card holders by creating an affinity rewards program using a credit card. The affinity company partners with an Issuing Bank to create affinity cards for customers. The Issuing Bank adds new customer account information including card number to its database 114. The affinity company creates entries in a database 113 of card holders which may contain card numbers or a tokenized number representing the card number for security reasons as is commonly known in the art. Other data stored by the affinity company in the Cardholder data entry can include identification information such as name, address, email, loginID and password for the phone App as well as Organizations IDs or organizations the Cardholder belongs to which may have qualified discount programs or other benefit programs. It is important to note that embodiments create a platform for consolidation of rewards from multiple organizations and can provide an all-in-one rewards service for purchases of any kind at any location including online. While the description of this invention illustrates rewards such as discounts or other promotions related to Organizations IDs there are other ways to group rewards. For instance, a discount or other promotion may be applied for all purchases at a Merchant or just for purchases of specific items or classes of items. A reward need not be a discount but might be a service or an action, an alarm, a notification or a gift, or other promotions.

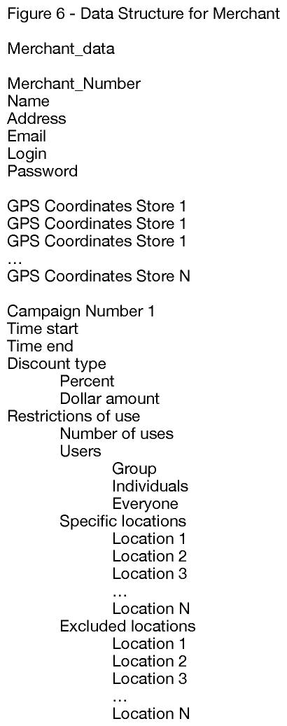

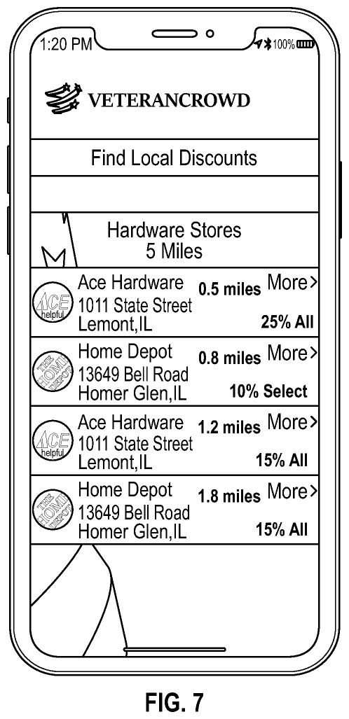

In an embodiment, a Merchant 103 creates an account with the affinity company on their Merchant Portal website served by a webserver 110 using web browser 202 executing on computer 203 through internet cloud 115 for purposes of creating rewards, such as discounts or other promotions, for Cardholders of the affinity company which will attract them to the Merchant's locations. For example, the Merchant may define campaigns to offer discounts during a specified time period or at specific locations. The campaign may be for all members of an organization or restricted in some way, perhaps even just for a specific Cardholder or group of Cardholders. Data defining the campaign is stored in database 113 as shown, for example, in FIG. 6 for the Merchant under its Merchant Number. As shown in FIG. 6, data defining the campaign includes data for implementing a campaign's rules, including, for example, campaign identification, Merchant identification, geographic scope, campaign start and stop dates and times, number of users and their identifications, discount amount and type or data for another type of promotion, and any other data required to implement the rules of a particular campaign. Note that not all of the exemplary data is always required for a particular campaign and other data may be required for a different campaign.

In an embodiment, a Cardholder would like to know the Merchants in the area offering rewards for their Organization. A smart phone 101 running an application 200, such as a smartphone application, is created by the affinity company, which provides geographic display of local Merchants and their discount levels or other promotions. Merchant discount data can be searched by category or keyword or simply viewed as a map with “pin” drops as is known to those in the art.

Smartphone App 200 communicates to the Application Database 113 via database Process software 207 running on the Application server 109 through Phone App Interface (PAI) Process 204 and DB Process 207 directly or through Phone App 204, Interaction Control Process (ICP) 205 and then ultimately DB Process 207. Alternate paths are available for high-speed download of larger data objects (direct) or processing (indirect).

Application 200's main interaction with Database 113 is to gather Merchant information. In an embodiment, application 200 passes global positioning satellite (GPS) corner coordinates of a screen displayed map to Interaction Control Process 205. ICP 205 or Auxiliary process 209 searches Database 113 via Database Process 207 for Merchants within the GPS corner coordinates of the map region. Auxiliary process 209 exists, in an embodiment, to provide parallel processing options in handling larger computing loads or performing specific processing tasks. Merchant data indicating those merchants in the geographic area defined by the corner GPS coordinates for the map region is returned from ICP 205 through PAI 204 to App process 200 and finally displayed on smartphone 101.

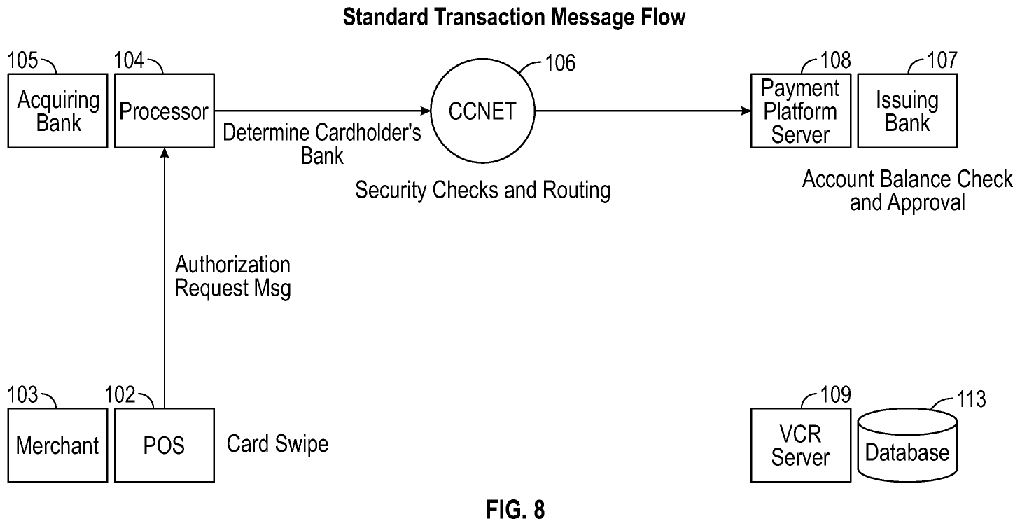

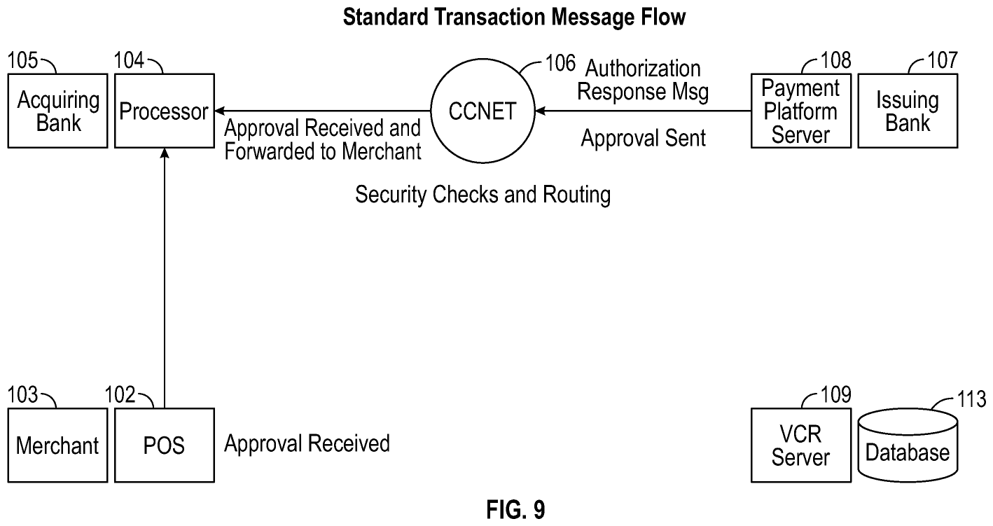

In an embodiment, application 200 may have many features to add convenience to the Cardholder. For instance, directions may be supplied after the Cardholder makes a point selection to select a particular merchant. The point selection can be through touching a touch screen or using a pointing device such as a mouse. Once a Cardholder has made a purchase at the Merchant, Card 100 or Smartphone 101 (through digital wallet and NFC or other methods known in the art) interacts with a point-of-sale (POS) system 102 at the merchant to begin the payment process. Card information such as the card number is combined with purchase information entered at the POS 102 via scanning or manual input in methods known to those in the art and passed to Gateway payment processor 104 and then to Acquiring Bank 105. Acquiring Bank 105 is the bank that acquires the Cardholder information and transaction details for presentation to and approval by Issuing Bank 107. Messages between entities in the credit card system widely use the ISO 8583 message protocol as shown in FIG. 8 and FIG. 9 and Table 1 and 2. POS 102 passes an ISO 8583 Authorization Request message to the Acquiring Bank 105 that then communicates it to the Issuing Bank 107. In a typical transaction, the Issuing Bank 107 checks the available funds in the Cardholder's account in database 114 and marks the transaction approved or denied.

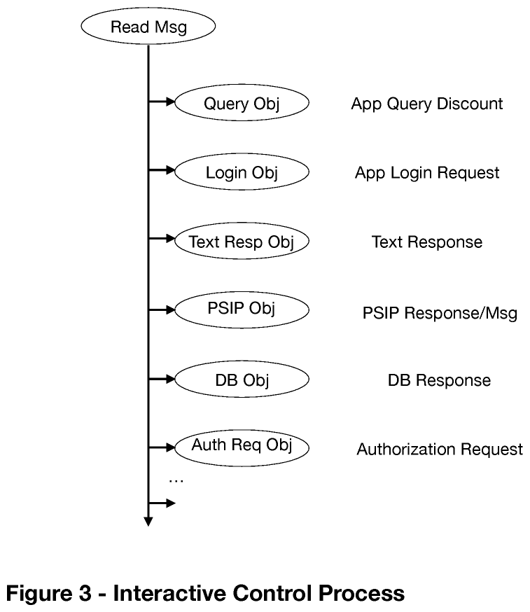

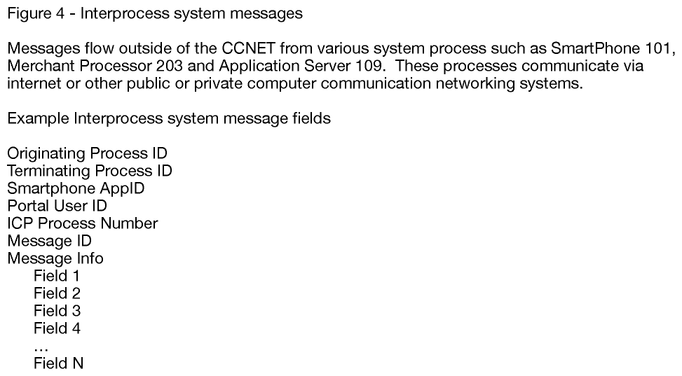

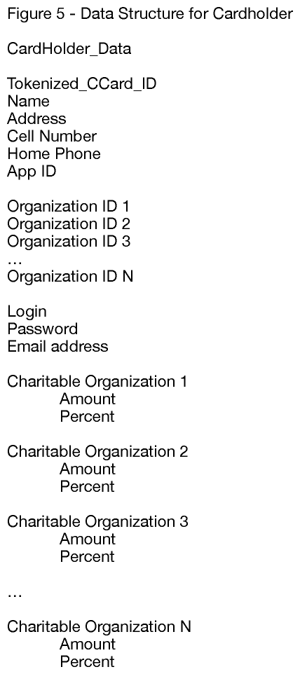

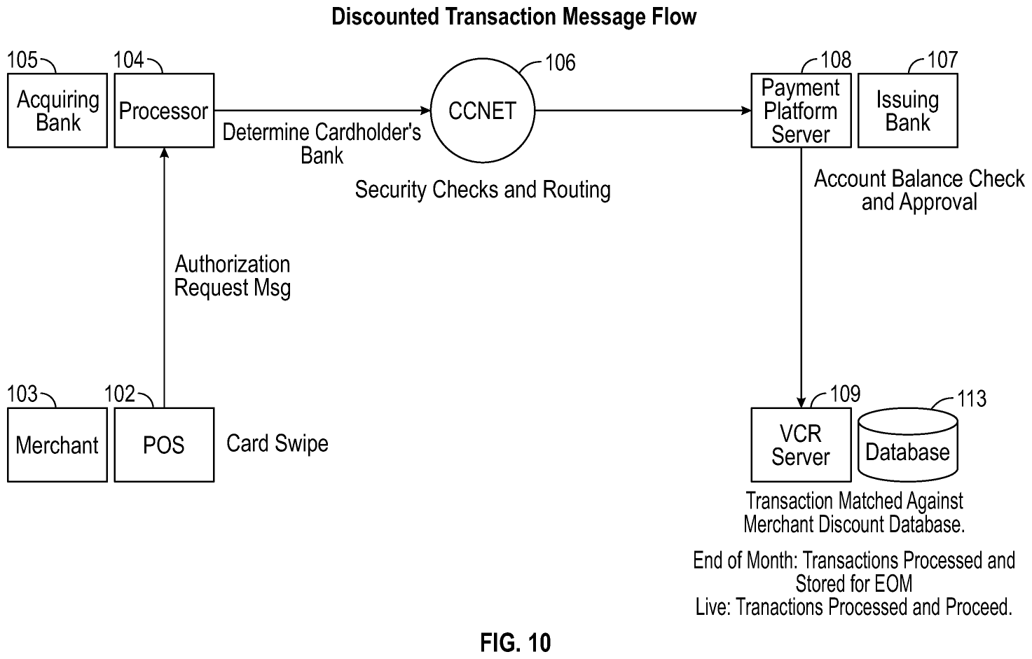

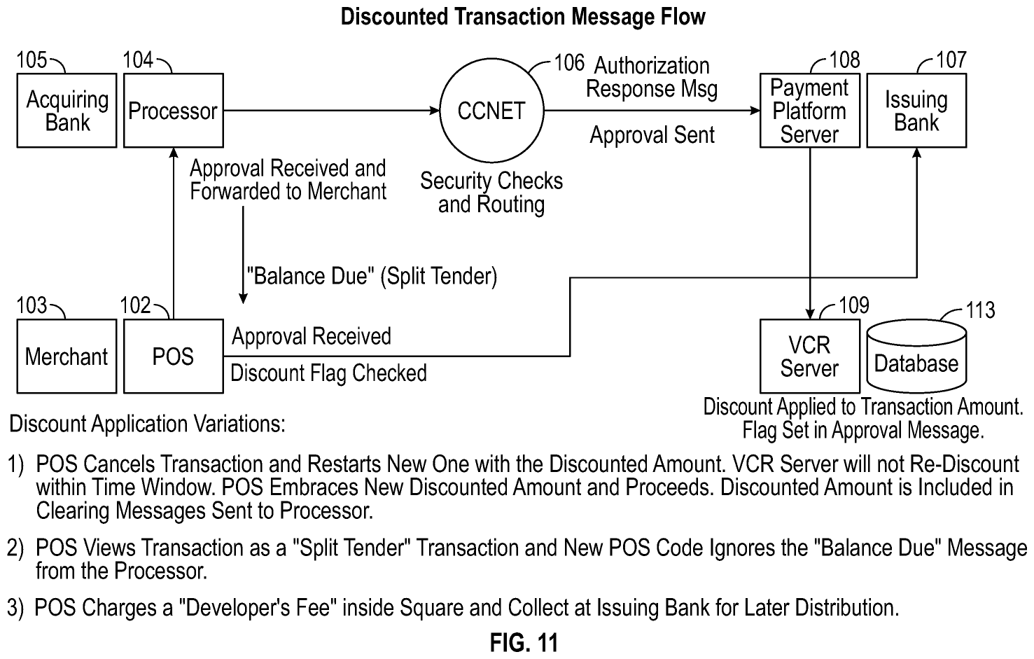

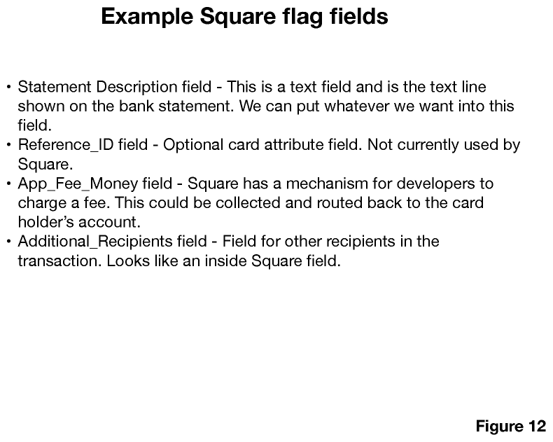

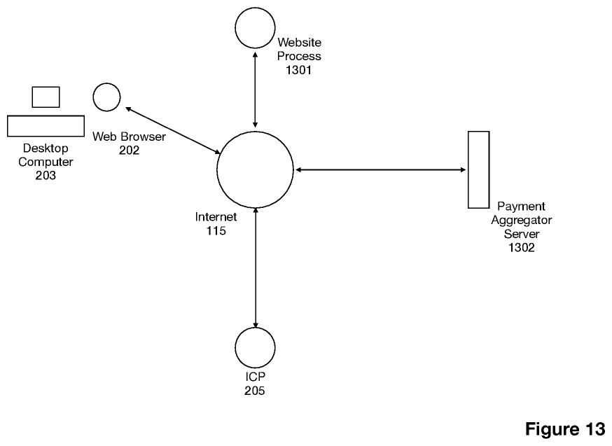

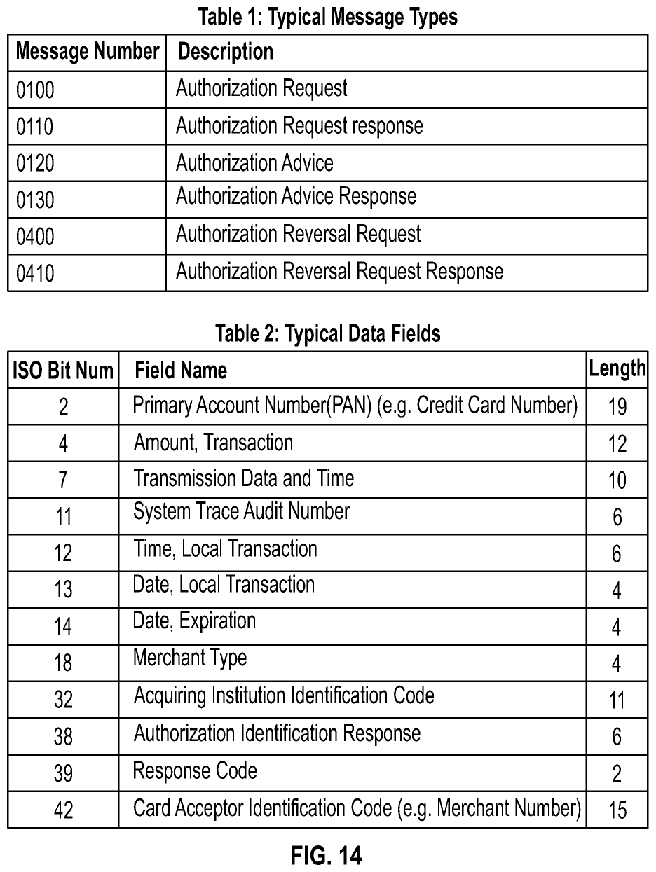

In an embodiment, Platform server 108 communicates transaction information from Issuing Bank 107's system or directly from CCNET 106 and passes transaction events to Application Server 109. Such Platform Servers 108 are available from providers such as Marqeta. Galileo and I2C among others, and usually provide their own message protocols and APIs for interface. Platform Server Interface Process (PSIP) 206 is passed incoming messages from CCNET and ICP 205 sources for processing. FIG. 3 shows an example of a basic message processing loop in ICP 205. In an embodiment, the Authorization Request message sent to the Issuing Bank 107, as shown in FIG. 10 and FIG. 11, results in a call to Query Obj in the App Query Discount message handler. App Query Discount queries database 113 for the Cardholder's tokenized card number and associated information such as that shown in FIG. 5 to see if this cardholder qualifies for any discounts or other promotions from any Organizations. Next the Merchant Number is used to query database 113 for information such as that shown in FIG. 6 for Organizations that offer discounts (or other promotions) and other discount (or other promotion) qualifying information such as times of valid discounts (or other promotions). If there is a match for this Cardholder then the discount is calculated and the amount of the purchase is reduced and a message passed back through ICP 205 to PSIP 206 where new amount value and a fee equal to the discount are entered into appropriate fields in the ISO 8583 Authorization Response message. Where the reward is another promotion, then information relevant to that type of promotion is sent back to the Cardholder. Platform server 108 passes the message back through the Issuing Bank 107 and through the Credit Card Network (CCNET) 106 or directly through CCNET 106 to the Acquiring Bank 105 (note, the “processor”, which routes messages and performs message handling functions, is sometimes called out separately of the Acquiring Bank or these functions may be merged).

In an embodiment, the Acquiring Bank 105 may check fields in the International Standards Organization (ISO) 8583 Authorization Response message for discounting and approve or adjust the discounted payment amount (and in some cases taxes) offered by the Issuing bank. In some cases, the POS system may need to be informed similarly of a discounted payment amount and it may need to also check fields in the ISO 8583 Authorization Response message and make adjustments to payment amount and in some cases taxes.

In an embodiment, some merchants may have discount programs in place for affinity group members that can be applied at checkout. In this case, the POS system should flag the transaction as “discount applied” so the ICP software process 205 and its subprocesses do not perform a second discount. This flag can be any unused field or any extension value in a field of the ISO 8583 Authorization Request message.

In an embodiment, some merchants may have discount programs in place for affinity group members that can be applied at checkout. In this case, the POS system should flag the transaction as “discount applied” so the ICP software process 205 and its subprocesses do not perform a second discount. This flag can be defined as part of the ISO 8583 or other card processing protocol.

In an embodiment, the Acquiring Bank 105 receives the authorization response message in the ISO 8583 protocol and detects a field in the message flagging the authorization as having been discounted (for instance the “statement description field” contents). Software in the Acquiring Bank will then view the payment as complete rather than a split tender transaction, generating a Balance Due message (as shown in FIG. 11).

In an embodiment, the Acquiring Bank 105 receives the authorization response message in the ISO 8583 protocol and detects a field in the message flagging the authorization as having been discounted. This field may be defined explicitly as an addition to the ISO 8583 or other card processing protocol. Software in the Acquiring Bank will then view the payment as complete rather than a split tender transaction, generating a Balance Due message (as shown in FIG. 11).

In an embodiment, a POS system 102, such as Square, allows debit of the transaction amount as a fee. This fee may be collected in aggregate by the affinity company and disbursed periodically as a way of managing the discounts. In this embodiment, standard message traffic and card processing is unchanged.

In an embodiment, the POS system 102 determines the transaction is discounted (through message field checks as previously discussed). This transaction is cancelled and another transaction with the discounted amount is generated. The transaction processing for this new discounted transaction proceeds to completion without any discount flagging or amount recalculation and changes. In this embodiment, ICP process 205 in Application Server 109 creates an entry in a leaky bucket table holding information needed to identify pending discounted transactions. ICP process 205 identifies this second transaction as the new discounted process by a match in this table of fields. For instance, the credit card token number will be the same, the amount of the transaction will match the discounted value in the original authorization request and the time interval between the first and second authorization requests will be short (for instance, within 20 seconds but probably much less). Once identified, the ICP process 205 will not further discount this transaction and allow it to proceed to completion.

In an embodiment, discount processing may take place later in the settlement message flow when funds are transferred. This may require checks for the discounted amount in the Acquiring bank's software. Such checks can be performed by reference to fields flagging the transaction as having been discounted by the Issuing bank. This can be done, for example in one of the discretionary data fields passed in the ACH data file between issuing and acquiring banks to affect funds transfer. In another method, the Acquiring Bank 105 can perform the same checks done by the Issuing Bank, with access to the same data sources (and described earlier), in the transfer of funds processing. In this case no data needs to be passed between banks although processing is redundant.

In an embodiment, the POS system of the merchant will pass details about the items purchased so these can be checked for discounting at the authorization and settlement processing. This information can either be “in band” of the 8583 messages or alternately, it can be passed “out of band”, in a variety of ways known to those in the art, to the Issuing Bank and the Application Server. This method is useful when discounts are being applied only to specific items within the purchase.

In an embodiment, the ICP 205 continues by sending a notification message to Text Services Control Process 208 in Text Server 112 to cause a text message to be sent to Smartphone 101 alerting the Cardholder they just received a discount from their Merchant on the purchase. The ICP 205 also makes an entry in the database 113 by sending a message to DB process 207.

In an embodiment, DB 113 accumulates data on Cardholders' activities that are of significant interest to Cardholders as well as Merchants. Admin process 210 produces reports to Cardholders at the end of each month assembling financial transaction data from DB 113 and DB 114. Merchant Portal process 110 contains code to create reports on Cardholder activity that can be assembled and displayed as is known in the art.

In an embodiment, ICP 205 performs a number of other functions as part of the Authorization Request processing. For instance, qualified discount Cardholders may wish part of their discount to be passed to a charitable organization. ICP 205 queries the DB 113 to check for charitable contribution election in the Cardholders profile. If there is a charitable election then ICP 205 sends a message to the Platform Server 108 to direct funds from the Cardholder's account representing the proper portion of the transaction discount to the appropriate charitable account.

In another embodiment, Auxiliary ICP 209 tracks trends in Cardholder purchases contained in DB 113 and other behavior such as location and activity from Smartphone 101 and collected and communicated through application process 200. Aux ICP 209 may apply various rules to create optimized offerings of discounts or other rewards advantageous to Cardholders. For instance, purchasing trends of a cardholder at lunch time when in a certain area may suggest a discount reward from a Merchant would be of interest. A program running in Aux ICP 209 might then communicate this opportunity to Merchants through Merchant Portal 110. In an embodiment, opportunities for cardholder rewards may be presented to multiple Merchants to be passed via an auction to the Merchant that is the highest bidder.

In an embodiment, the BIN number of the credit card or tokenized version of this number or other representing the card holder may be passed to discount or coupon processing software. Such software may be at checkout on a website, a plugin to a browser, an App on a smartphone or cookies for a search engine. When such number is known to be associated with secure affinity membership identity, such as the card contemplated here for veterans, then it may serve as a key for these software programs to apply or seek out further affinity centric discounts or coupons. For example, the software plugin joinhoney.com (copy attached as Appendix A) could check for this number and use this to trigger veteran discount levels or widen its search for coupons and discounts. Amazon could perform this check in a similar way to provide unique affinity discounts. More than discount checking and matching, funds could be dispersed to a referring organization as part of the transaction in ways known to those in the art.

In an embodiment, the credit card application processing system described can be paired with an aggregated payment processing system such as PayPal. FIG. 13 shows how the payment processed in an online purchase can interact with the credit card application processing system to enable discount processing. A customer using Web Browser 202 is making a purchase on Website 1301. In checkout, Website Process 1301 messages Payment Aggregator Server 1302. Payment Aggregator Server 1302 validates the ability of the customer to pay and responds to both the Website Process 1301 with an authorization response and ICP 205 through a web hook or interprocess message as is known in the art. In this embodiment, ICP 205 processes the notification for ACH payment of the discount at a later time.

In another embodiment, the credit card application processing system described is paired with an aggregated payment processing system such as PayPal. FIG. 13 shows how the payment processed in an online purchase can interact with the credit card application processing system to enable discount processing. A customer using Web Browser 202 is making a purchase on Website 1301. In checkout, Website Process 1301 messages Payment Aggregator Server 1302. Payment Aggregator Server 1302 validates the ability of the customer to pay and contacts ICP 205 with an interprocess message or webhook. ICP 205 performs checks of the database 113 and makes necessary adjustments of discount or rewards as described in previous embodiments or includes coupon codes for discount at the website as identified in database 113. ICP 205 then responds to Payment Aggregator Server 1302 with the modified data for the transaction. The Payment Aggregator Server 1302 then proceeds to complete the transaction with the Website Process 1301.

In an embodiment, integration of the credit card processing system with credit cards and payment aggregators creates a ubiquitous discount processing system where customers can shop both at stores and on the internet and receive automated discounts and other benefits of the system. This is a very powerful new method of providing discounts and other rewards.

What is claimed is:

1. A system for managing discounts in the payment transaction process at the Issuing Bank in a credit card system composed of:
An Application Server to receive transaction messages, formulate responses and determine qualifying transactions by comparison to values in database.
A database of merchants, discounts and codes of discount qualifying members.

2. The method of claim 1, wherein the Application Server calculates a new discounted payment amount and passes this back to the credit card system.

3. The method in claim 1, wherein the Application Server calculates a new discount amount and creates a database entry for batch ACH processing with the Merchant's bank.

4. The method in claim 1, wherein the Application Server calculates a new discount amount and sets a flag in the Authorization Response message to indicate to the credit card system that the transaction amount has been discounted.

5. The method in claim 4, wherein a POS system checks the Authorization Response message, cancels the transaction when it encounters a discount flag set and restarts a new transaction with the discounted amount.
